(19) United States
(12) Patent Application Publication
(10) Pub. No.: US 2011/0309562 A1
(43) Pub. Date: Dec. 22, 2011

(54) SUPPORT STRUCTURE AND PROCESSING APPARATUS

(75) Inventors: Shinji Asari, Oshu-Shi (JP); Mitsuhiro Okada, Nirasaki-Shi (JP)

(73) Assignee: Tokyo Electron Limited, Minato-Ku (JP)

(21) Appl. No.: 13/161,920

(22) Filed: Jun. 16, 2011

(30) Foreign Application Priority Data
Jun. 18, 2010 (JP) 2010-139145

(51) Int. Cl. B23Q 3/00

(52) U.S. Cl. 269/289 R

(57) ABSTRACT

A support structure for supporting a plurality of objects to be processed and to be disposed in a processing container structure in which a processing gas flows from the bottom to the top or from the top to the bottom, includes: a top plate portion; a bottom portion; and a plurality of support posts connecting the top plate portion and the bottom portion. A plurality of support portions for supporting the objects to be processed are formed in each support post along the longitudinal direction, and the pitch of the support portions is set larger on the downstream side than on the upstream side in the flow direction of the processing gas. The support structure can enhance the in-plane uniformity of the thickness of a film formed on a processing object.

### CROSS-REFERENCE TO RELATED APPLICATION

This application claims the benefit of Japanese Patent Application No. 2010-139145, filed on Jun. 18, 2010, the disclosure of which is incorporated herein by reference in its entirety.

### BACKGROUND OF THE INVENTION

1. Field of the Invention

The present invention relates to a support structure for supporting objects to be processed, such as semiconductor wafers, and to a processing apparatus.

2. Description of the Background Art

In the manufacturing of a semiconductor integrated circuit, a semiconductor wafer, e.g. comprised of a silicon substrate, is generally subjected to various types of processing, such as film-forming processing, etching, oxidation, diffusion processing, modification, removal of a natural oxide film, etc. Such processing is carried out by using a single-wafer processing apparatus which processes wafers in a one-by-one manner, or a batch processing apparatus which processes a plurality of wafers at a time. When processing of a semiconductor wafer is carried out e.g. by using a vertical batch processing apparatus as disclosed e.g. in patent document 1, semiconductor wafers are first transferred from a cassette, which can house a plurality of, e.g. about 25, wafers, to a vertical wafer boat where the wafers are supported in multiple stages.

The wafer boat can generally hold about 30 to 150 wafers, depending on the wafer size. After the wafer boat, housing wafers therein, is loaded into an evacuable processing container from below, the interior of the processing container is kept airtight. A predetermined heat treatment of the wafers is then carried out while controlling processing conditions, such as the flow rate of a processing gas, the processing pressure, the processing temperature, etc. Taking film-forming processing as an example of heat treatment, known film-forming methods include CVD (chemical vapor deposition) (patent document 2) and ALD (atomic layer deposition).

For the purpose of improving the characteristics of circuit elements, a demand exists for reducing heat history in the process of manufacturing a semiconductor integrated circuit. An ALD method, which involves intermittently supplying a raw material gas, etc. so as to repeatedly form one layer to a few layers of a film at the atomic or molecular level and which is capable of performing intended processing without exposing wafers to excessively high temperatures, is therefore becoming more frequently used (patent documents 3 and 4).

### PATENT DOCUMENTS p0 Patent document 1: Japanese Patent Laid-Open Publication No. H6-275608

Patent document 2: Japanese Patent Laid-Open Publication No. 2004-006551
Patent document 3: Japanese Patent Laid-Open Publication No. H6-45256
Patent document 4: Japanese Patent Laid-Open Publication No. H11-87341

### SUMMARY OF THE INVENTION

It is an object of the present invention to provide a support structure and a processing apparatus which can enhance the in-plane uniformity of the thickness of a film formed on an object to be processed.

In order to achieve the object, the present invention provides a support structure for supporting a plurality of objects to be processed and to be disposed in a processing container structure in which a processing gas flows from the bottom to the top or from the top to the bottom, comprising: a top plate portion; a bottom portion; and a plurality of support posts connecting the top plate portion and the bottom portion, wherein a plurality of support portions for supporting the objects to be processed are formed in each support post along the longitudinal direction, and the pitch of the support portions is set larger on the downstream side than on the upstream side in the flow direction of the processing gas.

Since the pitch of the support portions of a support post for supporting objects to be processed is set larger on the downstream side than on the upstream side in the flow direction of a processing gas, the processing gas can easily enter the spaces between objects to be processed lying on the downstream side of the flow of the processing gas. This makes it possible to enhance the in-plane uniformity of the thickness of a film formed on the objects to be processed lying on the downstream side.

The present invention also provides a support structure for supporting a plurality of objects to be processed and to be disposed in a processing container structure in which a processing gas flows horizontally from one side to the opposite side, comprising: a top plate portion; a bottom portion; and a plurality of support posts connecting the top plate portion and the bottom portion, wherein a plurality of support portions for supporting the objects to be processed are formed in each support post along the longitudinal direction, and the pitch of the support portions on the top side and the pitch of the support portions on the bottom side are set larger than the pitch of the support portions in the middle area.

According to the support structure which supports a plurality of objects to be processed on the support portions of each support post in a processing container structure in which a processing gas flows horizontally from one side to the opposite side, the pitch of the support portions on the top side and the pitch of the support portions on the bottom side are set larger than the pitch of the support portions in the middle area. This makes it possible to enhance the in-plane uniformity of the thickness of a film formed on the objects to be processed lying in the top and bottom areas of the support structure.

The present invention also provides a processing apparatus for carrying out predetermined processing of a plurality of objects to be processed, comprising: a vertical open-bottom processing container structure which is capable of housing the objects to be processed and in which a processing gas flows from the bottom to the top or from the top to the bottom; a lid for closing the bottom opening of the processing container structure; a support structure for supporting the objects to be processed and which can be inserted into and withdrawn from the processing container structure; a gas introduction means including a gas nozzle for introducing a gas into the processing container structure; an exhaust means for exhausting the atmosphere in the processing container structure; and a heating means for heating the objects to be processed, wherein the support structure comprises a top plate portion; a bottom portion; and a plurality of support posts connecting the top plate portion and the bottom portion, wherein a plurality of support portions for supporting the objects to be processed are formed in each support post along the longitudinal direction, and the pitch of the support portions is set larger on the downstream side than on the upstream side in the flow direction of the processing gas.

The present invention also provides a processing apparatus for carrying out predetermined processing of a plurality of objects to be processed, comprising: a vertical open-bottom processing container structure which is capable of housing the objects to be processed and in which a processing gas flows horizontally from one side to the opposite side; a lid for closing the bottom opening of the processing container structure; a support structure for supporting the objects to be processed and which can be inserted into and withdrawn from the processing container structure; a gas introduction means including a gas nozzle for introducing a gas into the processing container structure; an exhaust means for exhausting the atmosphere in the processing container structure; and a heating means for heating the objects to be processed, wherein the support structure comprises a top plate portion; a bottom portion; and a plurality of support posts connecting the top plate portion and the bottom portion, wherein a plurality of support portions for supporting the objects to be processed are formed in each support post along the longitudinal direction, and the pitch of the support portions on the top side and the pitch of the support portions on the bottom side are set larger than the pitch of the support portions in the middle area.

The support structure and the processing apparatus of the present invention can achieve the following advantageous effects.

According to the present invention, the pitch of the support portions of a support post for supporting objects to be processed is set larger on the downstream side than on the upstream side in the flow direction of a processing gas. This facilitates entry of the processing gas into the spaces between objects to be processed held on the downstream side of the support structure, making it possible to enhance the in-plane uniformity of the thickness of a film formed on the objects to be processed lying on the downstream side.

According to the present invention, in the support structure which supports a plurality of objects to be processed on the support portions of each support post in a processing container structure in which a processing gas flows horizontally from one side to the opposite side, the pitch of the support portions on the top side and the pitch of the support portions on the bottom side are set larger than the pitch of the support portions in the middle area. This makes it possible to enhance the in-plane uniformity of the thickness of a film formed on the objects to be processed lying in the top and bottom areas of the support structure.

### BRIEF DESCRIPTION OF THE DRAWINGS

FIG. 1 is a vertical sectional view of a processing apparatus including a support structure according to a first embodiment of the present invention;

FIG. 2 is a cross-sectional view of the support structure shown in FIG. 1;

FIGS. 3(A) and 3(B) are front views illustrating pitches in the support structure shown in FIG. 1;

FIG. 4 is a graph showing experimental data on the in-plane uniformity of film thickness;

FIG. 5 is a vertical sectional view of a processing apparatus including a support structure according to a second embodiment of the present invention;

FIG. 6 is a cross-sectional view of the support structure shown in FIG. 5;

FIG. 7 is a front view illustrating pitches in the support structure shown in FIG. 5;

FIG. 8 is a graph showing experimental data on step coverage;

FIG. 9 is a schematic view of an exemplary comparative batch processing apparatus; and

FIG. 10 is a schematic view of another exemplary comparative batch processing apparatus.

### DETAILED DESCRIPTION OF THE PREFERRED EMBODIMENTS

Preferred embodiments of a support structure and a processing apparatus according to the present invention will now be described in detail with reference to the drawings.

### First Embodiment

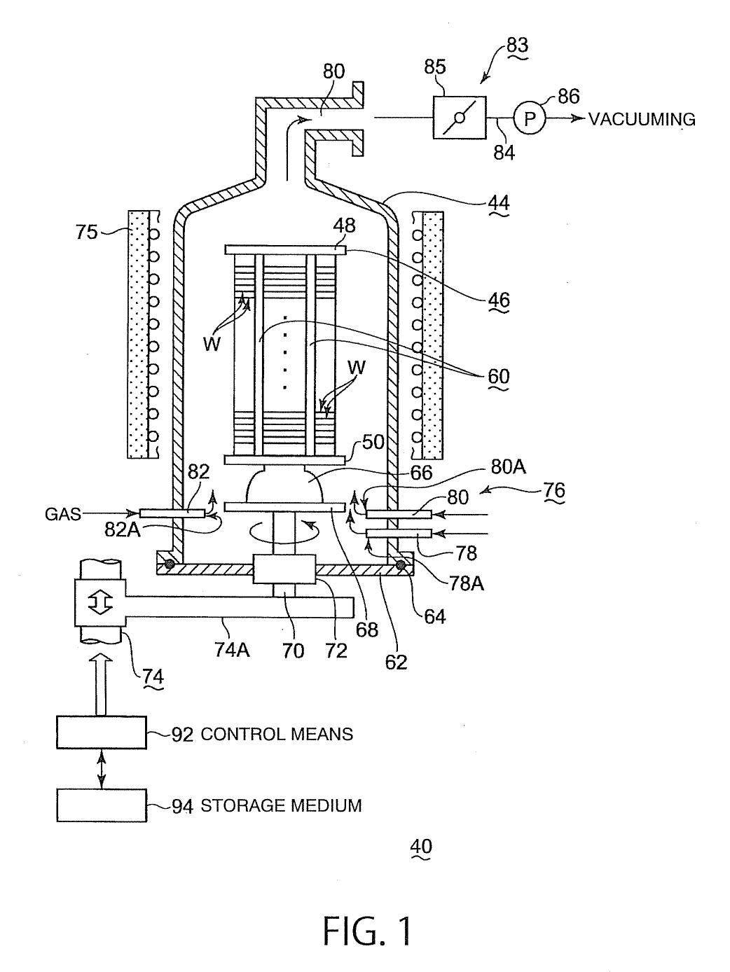

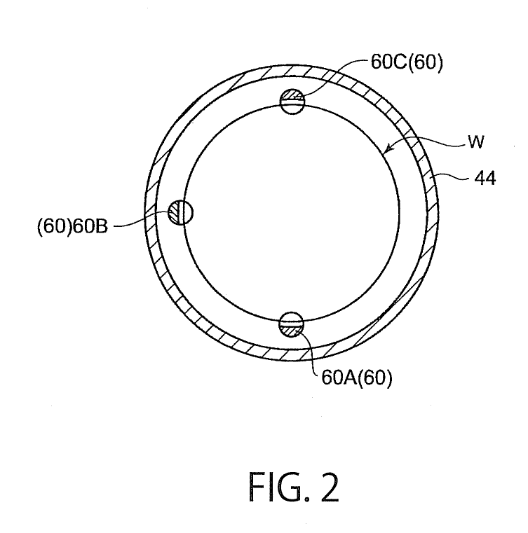

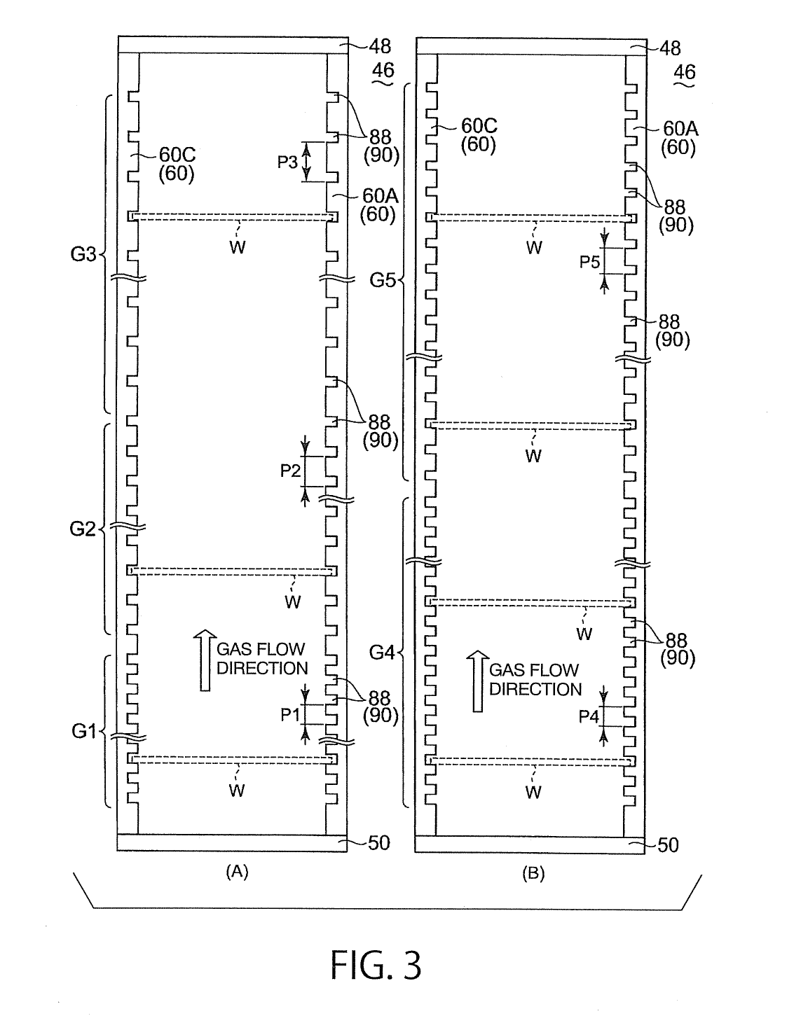

FIG. 1 is a vertical sectional view of a processing apparatus including a support structure according to a first embodiment of the present invention; FIG. 2 is a cross-sectional view of the support structure shown in FIG. 1; and FIGS. 3(A) and 3(B) are front views illustrating pitches in the support structure shown in FIG. 1. The following description illustrates an exemplary case in which the processing apparatus performs film-forming processing to form a film on a semiconductor wafer. As shown in FIG. 1, the processing apparatus 40 includes as a processing container structure 42 an open-bottom cylindrical vertical processing container 44 having a predetermined vertical length. The processing container 44 may, for example, be composed of quartz which is highly resistant to heat.

In the processing container 44 is housed a wafer boat 46 as a support structure in which a plurality of semiconductor wafers W as objects to be processed are supported in multiple stages. The wafer boat 46 is vertically movable and can be inserted upwardly into and withdrawn downwardly from the processing container 44. The entire wafer boat 46 is, for example, composed of quartz. The wafer boat 46 consists of a top plate portion 48 disposed at the top, a bottom portion 50 disposed at the bottom, and a plurality of support posts 60 connecting the top plate portion 48 and the bottom portion 50. Peripheral portions of the wafers W are placed and supported on support portions formed in each support post 60. The support portions will be described in detail below. The wafer boat 46 can support e.g. 50 to 150 wafers W having a diameter of 300 mm in multiple stages. The present invention, however, is not limited to the wafer size and the number of wafers.

After the wafer boat 46 is inserted into the processing container 44, the bottom opening of the processing container 44 is closed and hermetically sealed with a lid 62 e.g. made of quartz. A sealing member 64, such as an O-ring, is interposed between the lower end of the processing container 44 and the peripheral portion of the lid 62 to maintain airtightness. The lid 62 may be made of stainless steel. The wafer boat 46 is placed via a quartz heat-retaining base 66 on a table 68 which is supported on the upper end of a rotating shaft 70 that penetrates through the lid 62 for opening and closing the bottom opening of the processing container 44. A magnetic fluid seal 72, for example, is interposed between the rotating shaft 70 and the lid 62 to rotatably support the rotating shaft 70 while hermetically sealing the rotating shaft 70. The rotating shaft 70 is mounted to the front end of an arm 74A supported by a lifting mechanism 74, such as a boat elevator, so that the wafer boat 46, the lid 62, etc. can be vertically moved together.

A heating means 75, e.g. including a carbon wire heater, is provided around the processing container 44 so that the processing container 44 and the semiconductor wafers W in the container, lying inside the heating means 75, can be heated. A gas introduction means 76 for supplying a predetermined gas into the processing container 44 is provided at the lower end of the side wall of the processing container 44. The gas introduction means 76 includes a plurality of, for example three as shown, quartz gas nozzles 78, 80, 82. The gas nozzles 78 to 82 penetrate through the side wall of the processing container 44, and can eject gases from their front-end gas holes 78A, 80A, 82A toward the bottom area of the processing container 44. A film-forming raw material gas, an oxidizing gas and a purge gas may be used, and the gases can each be supplied as necessary at a controlled flow rate.

Gases to be used should, of course, vary according to the type of a film to be formed. The gas nozzles 78 to 80 are actually provided in a flange portion provided at the lower end of the processing container 44. It is also possible to provide a cylindrical stainless steel manifold at the bottom of the processing container 44, and to provide the gas nozzles 78 to 80 in the manifold.

An exhaust port 80, bent in a letter “L” shape, is provided in the ceiling portion of the processing container 44. The exhaust port 80 is connected to an exhaust means 83 for vacuuming the interior of the processing container 44. The exhaust means 83 includes an exhaust passage 84, and a pressure regulating valve 85 such as a butterfly valve and a vacuum pump 86, both interposed in the exhaust passage 84.

<Wafer Boat>

The wafer boat 46 as a support structure will now be described with reference also to FIGS. 2 and 3. FIG. 3(A) show a first example of the wafer boat, and FIG. 3(B) shows a second example of the wafer boat. As described above, the entire wafer boat 46 is formed of quartz which is heat resistant. The wafer boat 46 is comprised of a disk-shaped top plate portion 48, a disk-shaped bottom portion 50, and a plurality of support posts 60 which connect the top plate portion 48 and the bottom portion 50. In this embodiment, the support posts 60 consist of three support posts 60A, 60B, 60C which are arranged at equal intervals along the semicircular arc portion of the circular contour of a wafer W. Wafers W can be transferred by a not-shown transfer arm from the other semicircular arc side where the support posts 60A to 60C are not provided.

Support portions 88 for supporting wafers W are formed on the inner side of each of the three support posts 60A to 60C at appropriate intervals along the longitudinal direction. The support portions 88 are comprised of support grooves 90 formed by cutting the inner sides of the support posts 60A to 60C. Wafers W can be supported in multiple stages by placing peripheral portions of the wafers W on the support grooves 90.

The present invention is characterized in that the pitch of the support grooves 90 as the support portions 88 is set larger on the downstream side than on the upstream side in the flow direction of a processing gas flowing in the processing container 44. In this embodiment the processing gas flows upward from the bottom area to the ceiling portion in the processing container 44. Therefore, the bottom or lower side of the wafer boat 46 corresponds to the upstream side and the top or higher side of the wafer boat 46 corresponds to the downstream side. Thus, the pitch (spacing in the vertical direction) of the support grooves 90 is smaller on the bottom side of the wafer boat 46 than on the top side.

In particular, the support grooves 90 are divided into a plurality of groups along the flow direction of the processing gas. In the example shown in FIG. 3(A), the support grooves 90 are divided into three groups G1, G2, G3 from the bottom to the top of the wafer boat 46, and the pitches P1, P2, P3 of the support grooves 90 in the groups G1, G2, G3 are set as follows: P1<P2<P3. Thus, the spacing between two adjacent wafers W is made larger on the downstream side so that the processing gas can easily enter the spaces between wafers W on the downstream side. The pitch of the support grooves 90 is set constant in the same group.

The number of wafers to be supported in each of the groups G1 to G3 is, for example, ⅓ of the number of wafers to be supported in the entire wafer boat 46. Thus, assuming that a total of 90 wafers W can be supported in the entire wafer boat 46, 30 wafers W can be supported on the support grooves 90 of each group. The number of wafers in each group may appropriately be determined in consideration of the in-plane uniformity of the thickness of a film formed.

Regarding exemplary values for the pitches, the pitch P1 may be about 6.5 mm, the pitch P2 may be about 7.3 mm, and the pitch P3 may be about 8.0 mm. These values are not limitative. The pitches P1 to P3 may appropriately be determined in consideration of the in-plane uniformity of film thickness and the throughput that depends on the number of wafers which can be processed at a time.

Returning to FIG. 1, the overall operation of the thus-constructed processing apparatus is controlled by a control means 92 e.g. comprised of a computer. The control means 92 has a storage medium 94, such as a flexible disk, a flash memory, a hard disk, a CD-ROM or a DVD, for storing a computer-readable and writable program for controlling the overall operation of the apparatus.

<Operation of the Processing Apparatus>

The operation of the thus-constructed processing apparatus 40 will now be described. When the processing apparatus 40 is in a standby condition before loading of semiconductor wafers W such as silicon wafers, the processing apparatus 40 is kept at a lower temperature than a processing temperature. First, the wafer boat 46, holding a large number of, for example 90, wafers W at room temperature, is raised and loaded into the processing container 44, which has been brought to a hot wall condition by the heating means 75, and then the processing container 44 is hermetically sealed by closing the bottom opening of the processing container 44 with the lid 62.

While keeping the interior of the processing container 44 at a predetermined processing pressure by continually vacuuming the processing container 44 with the exhaust means 83, the temperature of the wafers W is raised to a processing temperature by increasing the power supplied to the heating means 75, and the processing temperature is maintained. Predetermined processing gases which are necessary to carry out film-forming processing are supplied from the gas nozzles 78 to 82 of the gas introduction means 76 into the processing container 44 while controlling the flow rate of each gas.

The wafer boat 46 holding the wafers W is rotating in the processing container 44, and the gases ejected from the gas holes 78A to 82A of the gas nozzles 78 to 82 flow upward in the processing container 44 while passing through the spaces between the wafers W. A film is deposited on the surfaces of the wafers W e.g. though an oxidation or decomposition reaction of a raw material gas. The film deposition is performed e.g. by thermal CVD. The atmosphere in the processing container 44, or the processing gases flowing upward in the processing container 44 while entering the spaces between the wafers W is discharged out of the container by the exhaust means 83 from the exhaust port 80 provided in the ceiling portion of the processing container 44.

The gases introduced from the gas nozzles 78 to 82 into the processing container 44 are gradually consumed by deposition of a film on the surfaces of the wafers W while the gases are flowing upward in the processing container 44. Thus, the concentrations of the gases, such as a raw material gas and an oxidizing gas, gradually decrease as the gases flow downstream, i.e. upward in the processing container 44 in this embodiment. In conventional processing apparatuses, wafers W are all arranged at a constant pitch, and therefore the amount of a processing gas, entering the spaces between wafers W, decreases as the gas flows downstream, resulting in a decrease in the in-plane uniformity of the thickness of a film formed.

According to the present invention, on the other hand, the pitch of the support grooves 90, i.e. the spacing between adjacent wafers W, is set larger on the downstream side than on the upstream side in the flow direction of a processing gas. Accordingly, the gas can easily enter the spaces between wafers W on the downstream side, making it possible to satisfactorily form a film despite the decrease in the gas concentration.

More specifically, with reference to the pitches P1 to P3 of the grooves 90 in the groups G1 to G3, shown in FIG. 3(A), the pitches satisfy the relation: P1<P2<P3. The wafer pitch thus increases stepwise from the upstream side (lower side) of the gas flow to the downstream side (upper side). In other words, the spacing between two adjacent wafers W is the smallest in the group G1 and increases stepwise in the order of group G1, group G2 and group G3, so that a gas can easily enter the spaces between wafers W in the upper groups. Therefore, even though the concentration of a processing gas decreases as the gas flows downstream (upward), the decrease in the gas concentration can be compensated for. The formation of a film can therefore be performed sufficiently even for wafers W lying on the downstream side of the gas flow, making it possible to enhance the in-plane uniformity of the film thickness.

Thus, according to the present invention, the pitch of the support portions of a support post for supporting objects to be processed is set larger on the downstream side than on the upstream side in the flow direction of a processing gas. This facilitates entry of the processing gas into the spaces between objects to be processed held on the downstream side of the support structure, making it possible to enhance the in-plane uniformity of the thickness of a film formed on the objects to be processed lying on the downstream side.

Though in the exemplary wafer boat 46 shown in FIG. 3(A), the support portions 88 are divided into the three groups G1 to G3 such that the number of wafers is equal among the groups, it is also possible to divide the support portions 88 into groups such that the length in the height direction of the wafer boat 46 is equal among the groups. The number of divided groups is not limited to 3, but may be any number not less than 2. For example, in the wafer boat 46 shown in FIG. 3(B), the support portions 88 are divided into two groups G4, G5, and the pitch P5 of the group G5 on the downstream side in the flow direction of a processing gas is set larger than the pitch of the group G4 on the upstream side (P4<P5). The length of the group G5 portion may, for example, be about ⅓ of the length of the wafer boat 46.

It is also possible not to divide the support portions 88 of the wafer boat 46 into groups but to set the spacings between the support portions 88 (support grooves 90) such that the spacings all differ from one another and gradually increase along the flow direction of a processing gas. Such a wafer boat can achieve the same advantageous effects as the above-described wafer boats.

Though in the processing apparatus shown in FIG. 1 a gas is allowed to flow upward from the bottom area to the top area of the processing container 44, the present invention can also be applied to a processing apparatus configured to allow a gas to flow downward from the top area to the bottom area of a processing container. In such a processing apparatus, contrary to the apparatus shown in FIG. 1, the top or upper area of the processing container corresponds to the upstream side of the gas flow, and the bottom or lower area of the processing container corresponds to the downstream side of the gas flow. Further, though in the apparatus shown in FIG. 1, the processing container structure 42 has a single tube structure consisting of the single processing container 44, the present invention can also be applied to a processing container structure of a double tube structure consisting of an inner cylinder and an outer cylinder surrounding the inner cylinder.

<Verification Experiment>

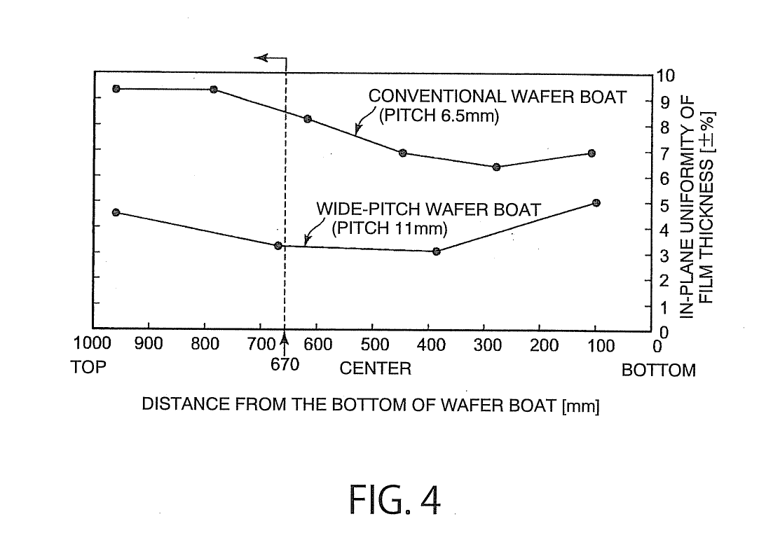

An experiment was conducted to verify the effectiveness of the present invention. In the experiment were used two wafer boats having the same length: one is a conventional boat having 143 support grooves arranged at a pitch of 6.5 mm; the other is a wafer boat having 85 support grooves arranged at a pitch of 11 mm. Using DSC (dichlorosilane), NH₃ and N₂ as processing gases, a silicon nitride film was formed on silicon wafers, held in the respective boats, under the same conditions of the flow rates of the gases, the processing temperature and the processing pressure. The processing gases were allowed to flow upward from the bottom area toward the top area of the processing container. FIG. 4 shows data on the in-plane uniformity of the thickness of the film, obtained in the experiment. In FIG. 4, the abscissa indicates the distance from the bottom of the wafer boat, the right end of the abscissa representing the bottom, and the left end representing the top.

As can be seen from the data in FIG. 4, compared to the use of the conventional wafer boat having a small wafer pitch, the use of the wafer boat having a large wafer pitch can obtain superior in-plane uniformity of film thickness for all the wafers. The use of a large pitch, however, decreases the number of wafers which can be held in the wafer boat, leading to a decrease in the throughput. Thus, as will be appreciated from the experimental data, the in-plane uniformity of film thickness can be enhanced, without a significant decrease in the throughput, by using a large wafer pitch only in that portion of the conventional wafer boat in which the in-plane uniformity of film thickness is especially poor, in particular the downstream-side portion whose length is about ⅓ of the length of the wafer boat, i.e. the portion lying higher than the position at a distance of 670 mm from the bottom of the wafer boat (the left side region in FIG. 4).

### Second Embodiment

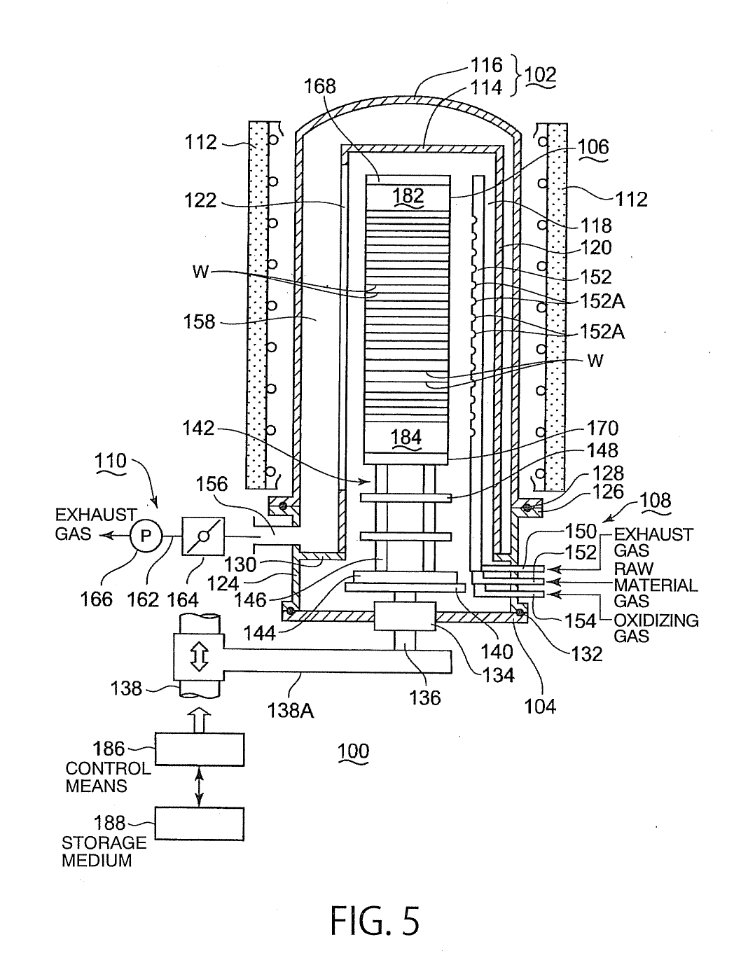

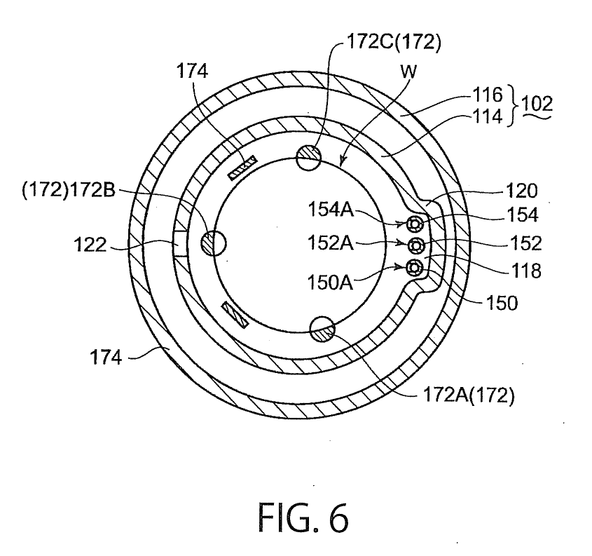

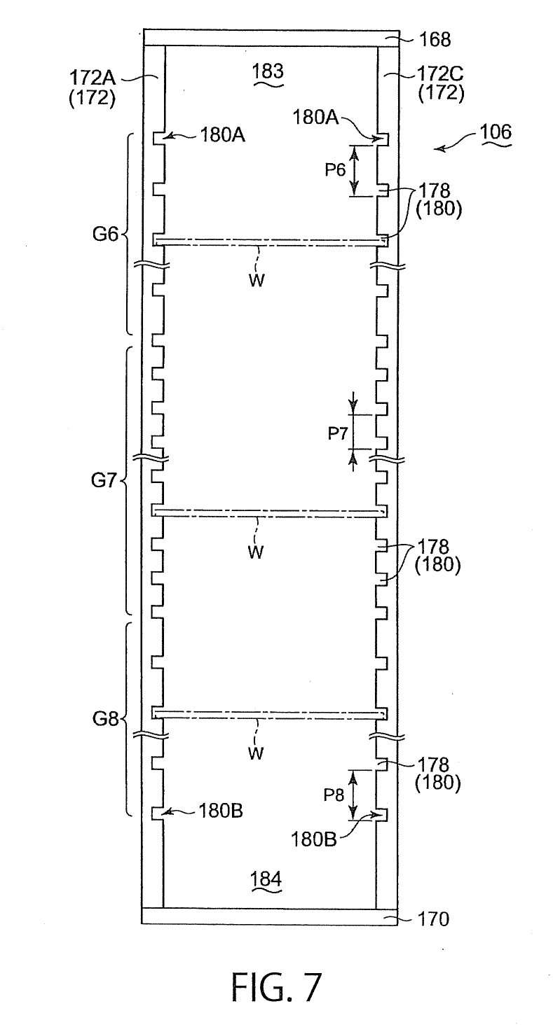

A support structure according to a second embodiment of the present invention will now be described. FIG. 5 is a vertical sectional view of a processing apparatus including a support structure according to a second embodiment of the present invention; FIG. 6 is a cross-sectional view of the support structure shown in FIG. 5; and FIG. 7 is a front view illustrating pitches in the support structure shown in FIG. 5.

As shown in FIG. 5, the processing apparatus 100 mainly comprises an upright processing container structure 102 for housing objects to be processed, a lid 104 for hermetically closing the opening at the lower end of the processing container structure 102, a wafer boat 106 as a support structure for supporting a plurality of semiconductor wafers W as objects to be processed at a predetermined pitch and which is to be inserted into and withdrawn from the processing container structure 102, a gas introduction means 108 for introducing a necessary gas into the processing container structure 102, an exhaust means 110 for exhausting the atmosphere in the processing container structure 102, and a heating means 112 for heating the semiconductor wafers W.

The processing container structure 102 is mainly comprised of a cylindrical processing container 114 with a closed top and an open bottom, and a cylindrical cover container 116 with a closed top and an open bottom, surrounding the exterior of the processing container 114. The processing container 114 and the cover container 116 are both composed of quartz which is resistant to heat, and are coaxially arranged in a double tube structure.

The ceiling portion of the processing container 114 is formed flatly. A nozzle housing area 118 for housing the below-described gas nozzles is formed on one side of the processing container 114 along the longitudinal direction. As shown in FIG. 6, the nozzle housing area 118 is formed inside an outwardly-bulging portion 120 of the side wall of the processing container 114.

A slit-like exhaust port 122 (see FIG. 6), whose width is constant along the longitudinal direction (vertical direction), is formed in the side wall of the processing container 114 at a position opposite the nozzle housing area 118 so that the atmosphere in the processing container 114 can be exhausted. The length of the slit-like exhaust port 122 is equal to or longer than the length of the wafer boat 106; the upper end of the exhaust port 122 is at the same or a higher level than the upper end of the wafer boat 106, and the lower end of the exhaust port 122 is at the same or a lower level than the lower end of the wafer boat 106. The lower end of the processing container structure 102 is supported by a cylindrical manifold 124 e.g. made of stainless steel.

The manifold 124 has, at its upper end, a flange portion 126 on which the lower end of the cover container 116 is mounted and supported. A sealing member 128, such as an O-ring, is interposed between the flange portion 126 and the lower end of the cover container 116 to keep the interior of the cover container 116 in a hermetic condition. Further, a ring-shaped support portion 130 is provided on an upper portion of the interior wall of the manifold 124, and the lower end of the processing container 114 is mounted and supported on the support portion 130. The lid 104 is hermetically mounted to the bottom opening of the manifold 124 via a sealing member 132, such as an O-ring, to hermetically close the bottom opening side of the processing container structure 102, i.e. the opening of the manifold 124. The lid 104 is, for example, formed of stainless steel.

A rotating shaft 136, penetrating though the lid 104, is provided via a magnetic fluid sealing portion 134 in the center of the lid 104. The lower end of the rotating shaft 136 is rotatably supported on the arm 138A of a lifting means 138 comprised of a boat elevator. The rotating shaft 136 is rotated by means of a not-shown motor. A rotating plate 140 is provided on the upper end of the rotating shaft 136. The wafer boat 106 for holding wafers W is placed on the rotating plate 140 via a quartz heat-retaining stand 142. Thus, the lid 104 moves vertically together with the wafer boat 106 by vertically moving the lifting means 138, so that the wafer boat 106 can be inserted into and withdrawn from the processing container structure 102.

The quartz heat-retaining stand 142 includes four support posts 146 (only two posts are shown in FIG. 5) mounted in an upright position on a base 144 and on which the wafer boat 106 is mounted and supported. The support posts 146 are provided with a plurality of heat-retaining plates 148 arranged at appropriate intervals in the longitudinal direction of the support posts 146.

On the other hand, the gas introduction means 108 for introducing a gas into the processing container 114 is provided in the manifold 124. More specifically, the gas introduction means 108 includes a plurality of, for example three as depicted, quartz gas nozzles 150, 152, 154. The gas nozzles 150 to 154 are disposed in the processing container 114 along the longitudinal direction, and the base end portions of the gas nozzles, bent in a letter “L” shape, penetrate through the manifold 124 and are thus supported.

As shown in FIG. 6, the gas nozzles 150 to 154 are disposed in the nozzle housing area 118 of the processing container 114 in a line along the circumferential direction. Gas holes 150A, gas holes 152A and gas holes 154A are formed in the gas nozzles 150, 152 and 154, respectively, at an appropriate pitch along the longitudinal direction of the nozzles so that a gas can be ejected in a horizontal direction from each of the gas holes 150A to 154A. The pitch of the gas holes 150A to 154A is set such that in the vertical direction each gas hole lies midway between vertically adjacent wafers W supported in the wafer boat 106 so that the respective gases can be supplied effectively to the spaces between the wafers W.

Examples of usable gases may include a raw material gas, an oxidizing gas and a purge gas. Such gases can be supplied as necessary though the gas nozzles 150 to 154 while controlling the flow rate of each gas. In this embodiment zirconium tetramethyl is used as a raw material gas, ozone is used as an oxidizing gas, and N₂ gas is used as a purge gas to form a ZrOx film by ALD. The type of a gas to be used should, of course, be changed according to the type of a film to be formed.

A gas outlet 156 is formed in an upper portion of the side wall of the manifold 124 and above the support portion 130 so that the atmosphere in the processing container 114, exhausted from the exhaust port 122 into the space 158 between the processing container 114 and the cover container 116, can be exhausted out of the system. The gas outlet 156 is provided with the exhaust means 110. The exhaust means 110 includes an exhaust passage 162 which is connected to the gas outlet 156 and in which a pressure regulating valve 164 and a vacuum pump 166 are interposed for vacuuming. The heating means 112 for heating the wafers W has a cylindrical shape, surrounding the outer periphery of the cover container 116.

<Wafer Boat>

The wafer boat 106 as a support structure will now be described. As described above, the entire wafer boat 106 is formed of quartz which is heat resistant. As shown in FIG. 7, the wafer boat 106 includes a disk-shaped top plate portion 168 located at the upper end of the boat, a disk-shaped bottom portion 170 located at the lower end of the boat, and a plurality of support posts 172 which connect the top plate portion 168 and the bottom portion 170 and which support wafers W in multiple stages. In this embodiment, the support posts 172 consist of three support posts 172A, 172B, 172C (see FIG. 6) which are arranged at equal intervals along the semicircular arc portion of the circular contour of a wafer W. Transfer of wafers is performed from the other semicircular arc side where the support posts 172A to 172C are not provided.

Plate-like quartz reinforcing support posts 174 (see FIG. 6), connecting the top plate portion 168 and the bottom portion 170, are provided approximately midway between the support posts 172A and 172B and between the support posts 172B and 172C to increase the strength of the wafer boat.

Support portions 178 for supporting wafers W are formed on the inner side of each of the three support posts 172A to 172C at an appropriate pitch along the longitudinal direction. The support portions 178 are comprised of support grooves 180 formed by cutting the inner sides of the support posts 172A to 172C. Wafers W can be supported in multiple stages by placing peripheral portions of the wafers W on the support grooves 180. The diameter of the wafers W is, for example, 300 mm, and about 50 to 150 wafers W can be supported in the wafer boat.

The present invention is characterized in that with reference to the pitch of the support grooves 180 as the support portions 178, the pitch of the support grooves 180 on the top side and the pitch of the support grooves 180 on the bottom side are set larger than the pitch of the support grooves 180 in the middle area. Thus, the wafer boat 106 is divided into a top area G6, a bottom area G7, and a middle area G7 lying midway between them. The pitch P6 of the support grooves 180 in the top area G6 and the pitch P8 of the support grooves 180 in the bottom area G8 are each set larger than the pitch P7 of the support grooves 180 in the middle area G7: P6>P7, P8>P7.

In the wafer boat 106, a space 182 having a wider width than the pitch P6 exists above the topmost support groove 180A. Similarly, a space 184 having a wider width than the pitch P8 exists below the lowermost support groove 180B. The pitch P6 of the top area G6 may be set equal to the pitch P8 of the bottom area G8. The number of wafers to be held in the top area G6 may either be the same as or different from the number of wafers to be held in the bottom area G8.

By thus setting the pitch P6 of the top area G6 and the pitch P8 of the bottom area G8 wider than the pitch P7 of the middle area G7, it becomes possible to facilitate entry of a processing gas into the wide spaces between wafers lying in the top and bottom areas, thereby enhancing the in-plane uniformity of the thickness of a film formed on the wafers. Though the number of wafers to be housed in each of the top area G6 and the bottom area G8 is not particularly limited, in order to facilitate wafer management, the number may be set equal to the number of wafers W, e.g. 25, which can be housed in a carrier box for transporting wafers W. Alternatively, in order to efficiently perform transfer of wafers W to the wafer boat 106, the number may be set equal to the number of wafers, e.g. 5, which can be held and transferred at a time by a not-shown transfer arm.

As regards exemplary values for the pitches of the support grooves 108 in the areas G6 to G8, the pitch P6 may be in the range of 6 to 16 mm, the pitch P7 may be in the range of 5 to 12 mm, and the pitch P8 may be in the range of 6 to 16 mm.

Returning to FIG. 5, the overall operation of the thus-constructed processing apparatus 100 is controlled by a control means 186 e.g. comprised of a computer. A computer program for performing the operation is stored in a storage medium 188 such as a flexible disk, a CD (compact disk), a hard disk, a flash memory or a DVD.

<Operation of the Processing Apparatus>

A film-forming processing, carried out by using the thus-constructed processing apparatus 100, will now be described. The following description illustrates the formation of a film, e.g. a ZrOx film, by the ALD method comprising a repetition of the cycle of supplying a raw material gas, e.g. zirconium tetramethyl, and an oxidizing gas, e.g. ozone, each in a pulsed manner for a predetermined time period. N₂ gas, for example, is used as a purge gas.

First, the wafer boat 106 holding a large number of, for example 50 to 150, 300-mm wafers W at room temperature, is raised and loaded into the processing container 114 of the processing container structure 102, which has been brought to a predetermined temperature, and then the processing container 114 is hermetically sealed by closing the bottom opening of the manifold 124 with the lid 104.

While keeping the interior of the processing container 114 at a predetermined processing pressure by continuously vacuuming the processing container 114, the temperature of the wafers W is raised to a processing temperature by increasing the power supplied to the heating means 112, and the processing temperature is maintained. The raw material gas is supplied from the gas nozzle 150 of the gas introduction means 108, ozone gas is supplied from the gas nozzle 152, and the purge gas is supplied from the gas nozzle 154. More specifically, the raw material gas is ejected horizontally from the gas holes 150A of the gas nozzle 150, ozone gas is ejected horizontally from the gas holes 152A of the gas nozzle 152, and the purge gas is ejected horizontally from the gas holes 154A of the gas nozzle 154. The raw material gas reacts with the ozone gas to form a ZrOx film on the surfaces of the wafers W supported in the rotating wafer boat 106.

The raw material gas and the oxidizing gas are supplied alternately and repeatedly in a pulsed manner as described above, and a purge period is provided between every consecutive time periods during which the processing gases are supplied. The purge gas is supplied during the purge period to promote discharge of the remaining processing gases. The respective gases, ejected from the gas holes 150A to 154A of the gas nozzles 150 to 154, flow horizontally toward the oppositely-located slit-like exhaust port 122 while passing between the wafers W supported in multiple stages, flow through the exhaust port 122 into the space 158 between the processing container 114 and the cover container 116, and are discharged through the gas outlet 156 to the outside of the processing container structure 102.

Because the gas holes 150A to 154A are arranged such that each gas hole lies at the same level as the space between adjacent wafers W, the respective gases flow in substantially laminar flow without causing a turbulent flow in the space between adjacent wafers W.

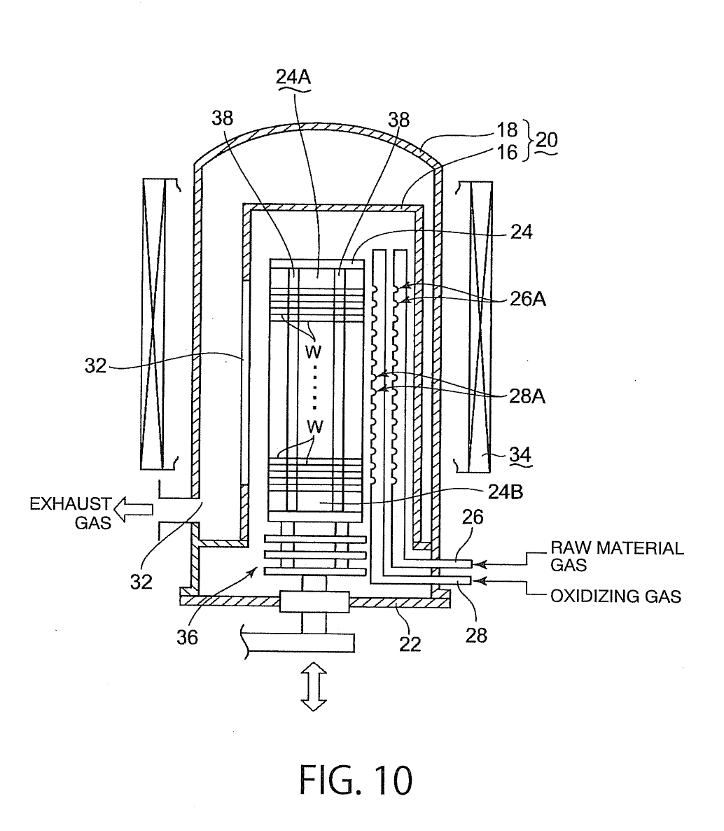

A comparative wafer boat, as will be described later with reference to FIG. 10, has large spaces 24A, 24B (see FIG. 10), having a vertical width larger than the pitch of wafers, in the top and bottom areas of the wafer boat. A gas flows at a fast velocity through the spaces 24A, 24B while the gas flows at a slow velocity through the spaces between wafers W lying in the top and bottom areas of the wafer boat, which may cause a turbulent gas flow.

According to the present invention, the pitch P6 of the support grooves 180 in the top area G6 of the wafer boat 106 and the pitch P8 of the support grooves 180 in the bottom area G6 of the wafer boat 106 are made larger than the pitch P7 of the support grooves 180 in the middle area G7. The width of the space between two adjacent wafers W is thus made wide in the top and bottom areas G6 and G8. This can increase the flow velocity of a processing gas that flows through the spaces between wafers W lying in the top area G6 and the bottom area G8, making it possible to sufficiently supply the processing gas to the wafers W.

Since a film-forming processing gas can thus be sufficiently supplied to wafers W lying in the top area G6 and the bottom area G8, the in-plane uniformity of the thickness of a film formed on the wafers W can be enhanced. It is as described above with reference to FIG. 4 that a large amount of a processing gas can be allowed to enter the wide spaces between wafers W.

Further, it is only necessary to set a wide wafer pitch in the top and bottom areas of the wafer boat 106. Therefore, compared to the case of setting a wide pitch in the entire wafer boat, there is no significant decrease in the number of wafers that can be held in the wafer boat, and thus the decrease in the throughput can be minimized.

Though in the apparatus shown in FIG. 5, the processing container structure 102 has a double tube structure consisting of the processing container 114 and the cover container 116 surrounding the outer periphery of the processing container 114, the present invention can be applied to any processing container structure in which a gas is ejected horizontally from a gas nozzle having a number of gas holes, disposed on one side of a processing container, and the atmosphere in the container is exhausted from a vertically extending slit-like exhaust port provided on the opposite side of the processing container.

<Evaluation of Step Coverage>

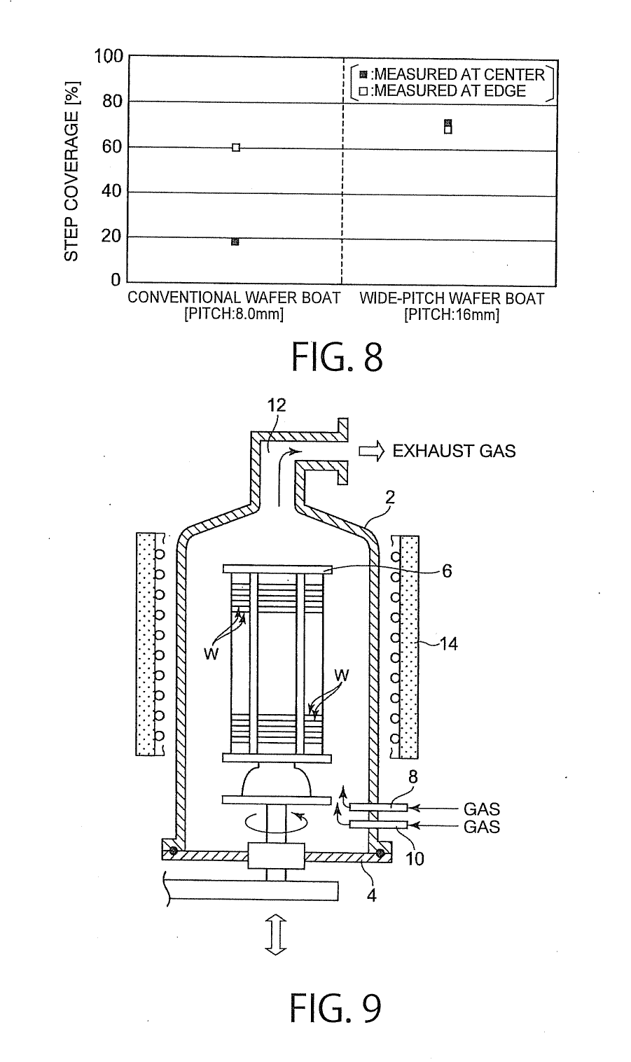

An experiment for evaluation of step coverage was conducted using a processing apparatus as shown in FIGS. 5 through 7. In the experiment were used two wafer boats having the same length: one is a conventional boat having 117 support grooves arranged at a pitch of 8.0 mm; the other is a wafer boat having 53 support grooves arranged at a pitch of 16 mm. Using zirconium tetramethyl and ozone as processing gases, a ZrOx film was formed by ALD on wafers W, held in the respective boats, under the same conditions of the flow rates of the gases, the processing temperature and the processing pressure. The processing gases were allowed to flow horizontally through the spaces between the wafers W as shown in FIG. 5. FIG. 8 shows data on the step coverage obtained in the experiment. The measurement of step coverage was performed for the center and the edge of each wafer.

As can be seen in FIG. 8, when the pitch of wafers W is narrow (8.0 mm), the side coverage is as high as 61.9% and thus is good in the edge, but is as low as 20% and thus is poor in the center. On the other hand, when the pitch of wafers W is wide (16 mm), the side coverage is 69% in the edge and 73.1% in the center, both indicating good side coverage. The experimental data thus verifies that the use of a wide wafer pitch can enhance the step coverage of the film formed on wafers lying in the top area (G6) and the bottom area (G8) of the wafer boat.

Though a ZrOx film is deposited on a wafer in the apparatus shown in FIG. 5, the present invention, of course, is not limited to deposition of the particular film. Though the apparatus shown in FIG. 5 employs the ALD film-forming method which involves alternate supply of a raw material gas and an oxidizing gas, the present invention can, of course, be applied to other film-forming methods, for example, the CVD method in which a raw material gas and a gas which reacts with the raw material gas are simultaneously supplied to wafers.

Semiconductor wafer as objects to be processed, usable in the present invention, include silicon wafers and compound semiconductor substrates such as GaAs, SiC, GaN, etc. The present invention can also be applied to other types of substrates, such as glass or ceramic substrates for use in liquid crystal display devices.

Exemplary comparative processing apparatuses will now be described.

FIG. 9 shows a schematic view of an exemplary comparative batch processing apparatus, and FIG. 10 shows a schematic view of another exemplary comparative batch processing apparatus. The processing apparatus shown in FIG. 9 is a processing apparatus of the type which allows a gas to flow from one side of a processing container toward the opposite side in the longitudinal direction of the container. As shown in FIG. 9, the processing apparatus includes a quartz open-top processing container 2 as a processing container structure. The bottom opening of the processing container 2 is openable and hermetically closable by a vertically movable lid 4. A quartz wafer boat 6, holding wafers W in multiple stages at a predetermined pitch, is housed in the processing container 2. The wafer boat 6 can be inserted upwardly into and withdrawn downwardly from the processing container 2. Gas nozzles 8, 10 are inserted into the bottom area of the processing container 2 so that necessary gases can be supplied to the bottom side of the processing container 2.

An exhaust port 12 is provided in the ceiling portion of the processing container 2, so that a gas flows from the bottom area of the processing container 2 to the top (ceiling portion), and is discharged from the exhaust port 12. The flowing gas makes contact with the surfaces of the wafers W and forms a film on the surfaces through a CVD reaction. A cylindrical heater 14 is provided around the outer periphery of the processing container 2 so that the wafers W supported in the wafer boat 6 can be heated to form a film by CVD.

The processing apparatus shown in FIG. 10 is a processing apparatus of the type which allows a gas to flow horizontally from one side of a vertical processing container toward the opposite side of the container. As shown in FIG. 10, the batch processing apparatus includes a processing container structure 20 consisting of a quartz closed-top processing container 16, and a quartz closed-top cover container 18 concentrically surrounding the circumference of the processing container 16. The bottom opening of the processing container structure 20 is openable and hermetically closable by a lid 22. A quartz wafer boat 24, holding wafers W in multiple stages, is housed in the processing container 16. The wafer boat 24 can be inserted upwardly into and withdrawn downwardly from the processing container structure 20. Gas nozzles 26, 28 are inserted into the processing container 16 from its bottom. The gas nozzles 26, 28 each have a large number of gas holes 26A, 28B arranged in the longitudinal direction of the nozzles, and necessary gases can be horizontally ejected from the gas holes 26A, 28A respectively at a controlled flow rate.

A vertically extending slit-like exhaust port 30 is formed in the side wall of the processing container 16 at a position opposite the gas nozzles 26, 28. A gas, exhausted from the exhaust port 30, can be exhausted out of the system from a gas outlet 32 provided in a lower portion of the side wall of the cover container 18. A cylindrical heater 34 for heating the wafers W supported in the wafer boat 24 is provided around the outer periphery of the processing container structure 20. The wafer boat 24 is placed on a heat-retaining stand 36 including a plurality of quartz support posts.

The wafer boat 24 includes a plurality of, for example three, support posts 38 (only two posts are shown in FIG. 10) which connect a top plate portion and a bottom portion. Wafers W can be supported by the three support posts 38 in multiple stages at a predetermined pitch.

In the processing apparatus, a film is deposited e.g. by ALD on the surface of each wafer W by horizontally ejecting a raw material gas and, for example, an oxidizing gas alternately and repeatedly from the gas holes 26A, 28A of the gas nozzles 26, 28. The gases in the processing container 16 are discharged from the slit-like exhaust port 30, and finally discharged out of the system from the gas outlet 32 provided in a lower portion of the side wall of the cover container 18.

As described above, in the processing apparatus shown in FIG. 9, a processing gas such as a film-forming gas is introduced into the bottom area of the processing container 2, and the gas flows upward in the processing container 2 and is discharged out of the container from the exhaust port 12 provided in the ceiling portion of the processing container 2. As the processing gas flows upward in the processing container 2, the processing gas is gradually consumed by the formation of a film and, therefore, the concentration of the processing gas gradually decreases.

The conventional processing apparatus thus has the problem of decreased in-plane uniformity of the thickness of the film formed on wafers W held in the top area of the wafer boat 6. Especially in the case of a multi-layer device structure having large surface irregularities, i.e. having a large gas consumption area, the decrease in the in-plane uniformity of film thickness is significant for wafers lying on the downstream side of the gas flow.

In the processing apparatus shown in FIG. 10, while wafers W are held in the wafer boat 24 at a predetermined constant pitch, spaces 24A, 24B, each having a larger width than the spacing between two adjacent wafers W, are formed respectively on the top side and on the bottom side of the wafer boat 24. The conductance for a gas flow is therefore larger in the spaces 24A, 24B than in the narrow spaces between wafers W, whereby the flow velocity of a gas flowing though the wide spaces 24A, 24B is higher than the flow velocity of the gas flowing between the wafers W. This causes a turbulent gas flow in the wide spaces 24A, 24B or their vicinity, resulting in low in-plane uniformity of the thickness of a film formed on wafers W lying in the top and bottom areas of the wafer boat 24.

On the other hand, as described hereinabove, the present invention enables enhancement of the in-plane uniformity of the thickness of a film formed on wafers.

What is claimed is:

1. A support structure for supporting a plurality of objects to be processed and to be disposed in a processing container structure in which a processing gas flows from the bottom to the top or from the top to the bottom, comprising:
a top plate portion;
a bottom portion; and
a plurality of support posts connecting the top plate portion and the bottom portion,
wherein a plurality of support portions for supporting the objects to be processed are formed in each support post along the longitudinal direction, and the pitch of the support portions is set larger on the downstream side than on the upstream side in the flow direction of the processing gas.

2. The support structure according to claim 1,
wherein the support portions of the support posts are divided into a plurality of groups along the flow direction of the processing gas, the pitch of the support portions being the same in the same group and different between different groups.

3. The support structure according to claim 1,
wherein the spacings between the support portions differ from one another along the flow direction of the processing gas.

4. The support structure according to claim 1,
wherein the support portions are comprised of support grooves.

5. A support structure for supporting a plurality of objects to be processed and to be disposed in a processing container structure in which a processing gas flows horizontally from one side to the opposite side, comprising:
a top plate portion;
a bottom portion; and
a plurality of support posts connecting the top plate portion and the bottom portion,
wherein a plurality of support
portions for supporting the objects to be processed are formed in each support post along the longitudinal direction, and the pitch of the support portions on the top side and the pitch of the support portions on the bottom side are set larger than the pitch of the support portions in the middle area.

6. The support structure according to claim 5,
wherein the pitch of the support portions on the top side is equal to the pitch of the support portions on the bottom side.

7. The support structure according to claim 5,
wherein the number of the support portions on the top side and the number of the support portions on the bottom side are each equal to the number of objects to be processed which can be housed in a carrier box for transporting objects to be processed.

8. The support structure according to claim 5,
wherein the number of the support portions on the top side and the number of the support portions on the bottom side are each equal to the number of objects to be processed which can be held and transferred at a time by a transfer arm for transferring objects to be processed.

9. A processing apparatus for carrying out predetermined processing of a plurality of objects to be processed, comprising:
a vertical open-bottom processing container structure which is capable of housing the objects to be processed and in which a processing gas flows from the bottom to the top or from the top to the bottom;
a lid for closing the bottom opening of the processing container structure;
a support structure for supporting the objects to be processed and which can be inserted into and withdrawn from the processing container structure;
a gas introduction means including a gas nozzle for introducing a gas into the processing container structure;
an exhaust means for exhausting the atmosphere in the processing container structure; and
a heating means for heating the objects to be processed,
wherein the support structure comprises a top plate portion;
a bottom portion; and
a plurality of support posts connecting the top plate portion and the bottom portion,
wherein a plurality of support portions for supporting the objects to be processed are formed in each support post along the longitudinal direction, and the pitch of the support portions is set larger on the downstream side than on the upstream side in the flow direction of the processing gas.

10. A processing apparatus for carrying out predetermined processing of a plurality of objects to be processed, comprising:
a vertical open-bottom processing container structure which is capable of housing the objects to be processed and in which a processing gas flows horizontally from one side to the opposite side;
a lid for closing the bottom opening of the processing container structure;
a support structure for supporting the objects to be processed and which can be inserted into and withdrawn from the processing container structure;
a gas introduction means including a gas nozzle for introducing a gas into the processing container structure;
an exhaust means for exhausting the atmosphere in the processing container structure; and
a heating means for heating the objects to be processed,
wherein the support structure comprises a top plate portion;
a bottom portion; and
a plurality of support posts connecting the top plate portion and the bottom portion,
wherein a plurality of support portions for supporting the objects to be processed are formed in each support post along the longitudinal direction, and the pitch of the support portions on the top side and the pitch of the support portions on the bottom side are set larger than the pitch of the support portions in the middle area.
